(19) United States
(12) Patent Application Publication
(10) Pub. No.: US 2026/0039032 A1
(43) Pub. Date: Feb. 5, 2026

(54) ELECTRONIC DEVICE

(71) Applicant: InnoLux Corporation, Miao-Li County (TW)

(72) Inventors: Jen-Hai CHI, Miao-Li County (TW); Zhi-Fu HUANG, Miao-Li County (TW); Chih-Yung HSIEH, Miao-Li County (TW); Ying-Jen CHEN, Miao-Li County (TW); Chien-Min CHAO, Miao-Li County (TW)

(21) Appl. No.: 19/259,823

(22) Filed: Jul. 3, 2025

Related U.S. Application Data
(60) Provisional application No. 63/678,226, filed on Aug. 1, 2024.

(30) Foreign Application Priority Data
Feb. 14, 2025 (CN) 202510163248.8

(51) Int. Cl. H01Q 21/28; G02F 1/1339; G02F 1/1347; H01Q 1/22; H01Q 1/38; H01Q 1/42

(52) U.S. Cl. CPC H01Q 21/28; G02F 1/1339; G02F 1/1347; H01Q 1/2283; H01Q 1/38; H01Q 1/425

(57) ABSTRACT

An electronic device has a dimming area and an antenna area, and includes: a first substrate; a second substrate opposite to the first substrate; a first light modulation layer disposed between the first substrate and the second substrate and located in the dimming area; and a first antenna electrode disposed on a side of the first substrate adjacent to the first light modulation layer and located in the antenna area, wherein the first light modulation layer includes a liquid crystal material.

### CROSS-REFERENCE TO RELATED APPLICATIONS

This application claims the benefits of the Chinese Patent Application Serial Number 202510163248.8, filed on Feb. 14, 2025, the subject matter of which is incorporated herein by reference.

This application claims the benefit of filing date of U.S. Provisional Application Ser. No. 63/678,226, filed Aug. 1, 2024 under 35 USC § 119(e)(1).

### BACKGROUND

### Field

The present disclosure provides an electronic device. More particularly, the present disclosure provides an electronic device with antenna function.

### Description of Related Art

Smart glass or smart window refers to a device that can be controlled to switch the glass or window to present a light-transmitting state, a dark state (discoloration state), a foggy state, etc. to change the light transmittance, so as to achieve the effects of dimming and/or heat insulation.

However, as communication technology changes, it has gradually developed towards high-frequency signals. In addition, the transparent electrode layer in smart glass or smart window may shield the signal of the communication device, causing the high-frequency signal to be greatly attenuated. Therefore, it is still necessary to overcome the problem of poor indoor signal.

Therefore, it is desirable to provide a novel electronic device to solve the aforesaid defects.

### SUMMARY

The present disclosure provides an electronic device having a dimming area and an antenna area, and comprising: a first substrate; a second substrate opposite to the first substrate; a first light modulation layer disposed between the first substrate and the second substrate and located in the dimming area; and a first antenna electrode disposed on a side of the first substrate adjacent to the first light modulation layer and located in the antenna area, wherein the first light modulation layer comprises a liquid crystal material.

Other novel features of the disclosure will become more apparent from the following detailed description when taken in conjunction with the accompanying drawings.

### BRIEF DESCRIPTION OF DRAWINGS

FIG. 1 is a schematic view showing positions of a first dimming area and a first antenna area of an electronic device according to one embodiment of the present disclosure.

FIG. 2 is a schematic view showing positions of a first dimming area and a first antenna area of an electronic device according to another embodiment of the present disclosure.

FIG. 3 is a cross-sectional schematic view of an electronic device according to one embodiment of the present disclosure.

FIG. 4 is a schematic view of a first antenna electrode being a mesh in an electronic device according to another embodiment of the present disclosure.

FIG. 5 is a schematic view of a first antenna electrode being a patch in an electronic device according to further another embodiment of the present disclosure.

FIG. 6 is a cross-sectional schematic view of an electronic device according to further another embodiment of the present disclosure.

FIG. 7 is a cross-sectional schematic view of an electronic device according to further another embodiment of the present disclosure.

FIG. 8 is a partial cross-sectional schematic view of the electronic device of FIG. 7.

FIG. 9 is a cross-sectional schematic view of an electronic device according to further another embodiment of the present disclosure.

FIG. 10 is a cross-sectional schematic view of an electronic device according to further another embodiment of the present disclosure.

FIG. 11 is a cross-sectional schematic view of an electronic device according to further another embodiment of the present disclosure.

FIG. 12 is a cross-sectional schematic view of an electronic device according to further another embodiment of the present disclosure.

FIG. 13 is a cross-sectional schematic view of an electronic device according to further another embodiment of the present disclosure.

FIG. 14 is a cross-sectional schematic view of an electronic device according to further another embodiment of the present disclosure.

FIG. 15 is a cross-sectional schematic view of an electronic device according to further another embodiment of the present disclosure.

FIG. 16 is a schematic view showing positions of a dimming area and an antenna area of an electronic device according to another embodiment of the present disclosure.

FIG. 17 is a cross-sectional schematic view of an electronic device according to further another embodiment of the present disclosure.

FIG. 18 is a cross-sectional schematic view of an electronic device according to further another embodiment of the present disclosure.

### DETAILED DESCRIPTION

The following is a detailed description of the electronic device according to the embodiment of the present disclosure. It should be understood that the following description provides many different embodiments for implementing different aspects of some embodiments of the present disclosure. Specific examples of each component and its configuration are described below to simplify the embodiments of the present disclosure. Of course, these are only examples and are not intended to limit the present disclosure. In addition, similar and/or corresponding reference numerals may be used to identify similar and/or corresponding elements in different embodiments to clearly describe the present disclosure. However, the use of these similar and/or corresponding reference numerals is only for the purpose of simply and clearly describing some embodiments of the present disclosure, and does not imply any correlation between the different embodiments and/or structures discussed.

The embodiments of the present disclosure may be understood in conjunction with the drawings, which are also considered part of the disclosure. It should be understood that the drawings of the present disclosure are not drawn to scale, and in fact, the size of the elements may be arbitrarily enlarged or reduced in order to clearly show the features of the present disclosure. In addition, the directional terms mentioned in the present disclosure, such as “up”, “down”, “front”, “back”, “left”, “right”, etc., are only referenced to the directions of the accompanying drawings. Therefore, the directional terms used are for illustration and are not intended to limit the present disclosure. In the accompanying drawings, each diagram depicts the general characteristics of the methods, structures and/or materials used in a particular embodiment. However, these diagrams should not be interpreted as defining or limiting the scope or nature covered by these embodiments. For example, for the sake of clarity, the relative size, thickness and position of each layer, region and/or structure may be reduced or enlarged.

One structure (or layer, component, or substrate) described in the present disclosure is located on/above another structure (or layer, component, or substrate). This may mean that the two structures are adjacent and directly connected, or the two structures are adjacent rather than directly connected. Indirect connection means that there is at least one intermediary structure (or intermediary layer, intermediary component, intermediary substrate, or intermediary spacer) between two structures. The lower surface of one structure is adjacent to or directly connected to the upper surface of the intermediary structure, and the upper surface of another structure is adjacent to or directly connected to the lower surface of the intermediary structure. The intermediary structure can be composed of a single-layer or multi-layer solid structure or a non-solid structure, and there is no limit. In the present disclosure, when a structure is disposed “on” another structure, it may mean that the structure is “directly” on the other structure, or that the structure is “indirectly” on the other structure, that is, at least one structure is also sandwiched between the structure and the other structure.

In addition, it should be understood that the ordinal numbers used in the description and the claims, such as “first”, “second”, etc., are intended only to describe the elements claimed and imply or represent neither that the (these) elements have any proceeding ordinals, nor that sequence between one claimed element and another claimed element or between steps of a manufacturing method. The use of these ordinals is merely to differentiate one claimed element having a certain designation from another claimed element having the same designation. The same words may not be used in the claim and the description. For example, the first element in the description may be the second element in the claim.

In some embodiments of the present disclosure, terms related to joining and connecting, such as “connection”, “interconnection”, etc., unless otherwise defined, may mean that two structures are in direct contact, or may also mean that two structures are not in direct contact where other structures are located between these two structures. The terms “joint” and “connection” can also include situations where both structures are movable, or where both structures are fixed. In addition, the terms “electrical connection” or “coupling” include any direct and indirect means of electrical connection.

In the present specification, the terms, such as “about”, “substantially”, or “approximately”, are generally interpreted as within 10%, 5%, 3%, 2%, 1%, or 0.5% of a given value or range. Unless otherwise stated, when a value is “in a range from a first value to a second value” or “in a range between a first value and a second value”, the value can be the first value, the second value, or another value between the first value and the second value. In addition, any two values or directions used for comparison may have certain errors. If the first value is equal to the second value, it implies that there may be an error of about 10% between the first value and the second value. If the first direction is perpendicular to the second direction, the angle between the first direction and the second direction may be between 80° and 100°. If the first direction is parallel to the second direction, the angle between the first direction and the second direction may be between 0° and 10°. In the present disclosure, the term “the given range is from the first value to the second value” and “the given range falls within the range of the first value to the second value” mean that the given range includes the first value, the second value and another value between the first value and the second value.

Furthermore, according to embodiments of the present disclosure, optical microscopy (OM), scanning electron microscope (SEM), film thickness profile measuring instrument (α-step), ellipsometer, or other suitable methods are used to measure the thickness, length or width of each component or the distance and angle between components. Specifically, according to some embodiments, a scanning electron microscope can be used to obtain cross-sectional images of the structure and measure the thickness, length or width of each component or distance and angle between components.

In the specification and the appended claims of the present disclosure, certain words are used to refer to specific elements. Those skilled in the art should understand that electronic device manufacturers may refer to the same components by different names. The present specification does not intend to distinguish between elements that have the same function but have different names. In the following description and claims, words such as “comprising”, “including”, “containing”, and “having” are open-ended words, so they should be interpreted as meaning “containing but not limited to . . . ”. Therefore, when the terms “comprising”, “including”, “containing” and/or “having” are used in the description of the present disclosure, they specify the existence of corresponding features, regions, steps, operations and/or components, but do not exclude the existence of one or more corresponding features, regions, steps, operations and/or components.

It should be noted that the following embodiments may be implemented by replacing, reorganizing, or mixing features of several different embodiments without departing from the spirit of the present disclosure to implement other embodiments. The features of the various embodiments may be mixed and matched as desired as long as they do not violate the spirit of the invention or conflict with each other.

In the present specification, except otherwise specified, the terms (including technical and scientific terms) used herein have the meanings generally known by a person skilled in the art. It should be noted that, except otherwise specified in the embodiments of the present disclosure, these terms (for example, the terms defined in the generally used dictionary) should have the meanings identical to those known in the art, the background of the present disclosure or the context of the present specification, and should not be read by an ideal or over-formal way. The present disclosure may be understood by referring to the following detailed description in conjunction with the accompanying drawings. It should be noted that, for the sake of ease of understanding for readers and simplicity of the drawings, many of the drawings in the present disclosure only depict a portion of an electronic device, and specific components in the drawings are not drawn according to actual scale. In addition, the number and size of each component in the figures are only for illustration and are not intended to limit the scope of the present disclosure.

The electronic device of the present disclosure may include electronic components, and the electronic components can include passive components, active components or a combination thereof, such as capacitors, resistors, inductors, varactor diodes, variable capacitors, filters, diodes, transistors, sensors, microelectromechanical system components (MEMS), liquid crystal chips, etc., but the present disclosure is not limited thereto. The diode may include light emitting diode or non-light emitting diode. The diode includes a P-N junction diode, a PIN diode or a constant current diode. The light emitting diode may include, for example, an organic light emitting diode (OLED), a mini LED, a micro LED, a quantum dot LED, fluorescence, phosphors, other suitable material or a combination thereof, but the present disclosure is not limited thereto. The sensor may include, for example, a capacitive sensor, an optical sensor, an electromagnetic sensor, a fingerprint sensor (FPS), a touch sensor, an antenna or a pen sensor, but the present disclosure is not limited thereto. In the following, the display device will be used as an electronic device to illustrate the content of the present disclosure, but the present disclosure is not limited thereto.

The electronic device may include an imaging device, a laminating device, a display device, a backlight device, an antenna device, a tiled device, a touch electronic device (a touch display), a curved electronic device (a curved display) or a non-rectangular electronic device (a free shape display), but the present disclosure is not limited thereto. The electronic device may include liquid crystals, light emitting diodes, fluorescence, phosphors, other suitable display media, or a combination thereof, but the present disclosure is not limited thereto. The display device may be a non-self-luminous display device or a self-luminous display device. The antenna device may be a liquid crystal antenna device or a non-liquid crystal antenna device. The sensing device may be a sensing device that can sense capacitance, light, heat energy or ultrasonic waves. But, the present disclosure is not limited thereto. The tiled device may be, for example, a tiled display device or a tiled antenna device, but is not limited thereto. It should be noted that the electronic device may be any permutation and combination of the above, but is not limited thereto. The electronic device may be a bendable or flexible electronic device. It should be noted that the electronic device may be any permutation and combination of the above, but not limited to this. In addition, the shape of the electronic device may be rectangular, circular, polygonal, or having a shape with curved edges or other suitable shapes. The electronic device may have peripheral systems such as drive systems, control systems, light source systems, shelf systems, etc. to support the display device, the antenna device or the tiled device. It should be noted that the following embodiments may be implemented by replacing, reorganizing, or mixing features of several different embodiments without departing from the spirit of the present disclosure to implement other embodiments. The features of the various embodiments may be mixed and matched as desired as long as they do not violate the spirit of the invention or conflict with each other. It should be noted that the technical solutions provided in the following different embodiments can be replaced, combined or mixed with each other to form another embodiment without violating the spirit of the present disclosure.

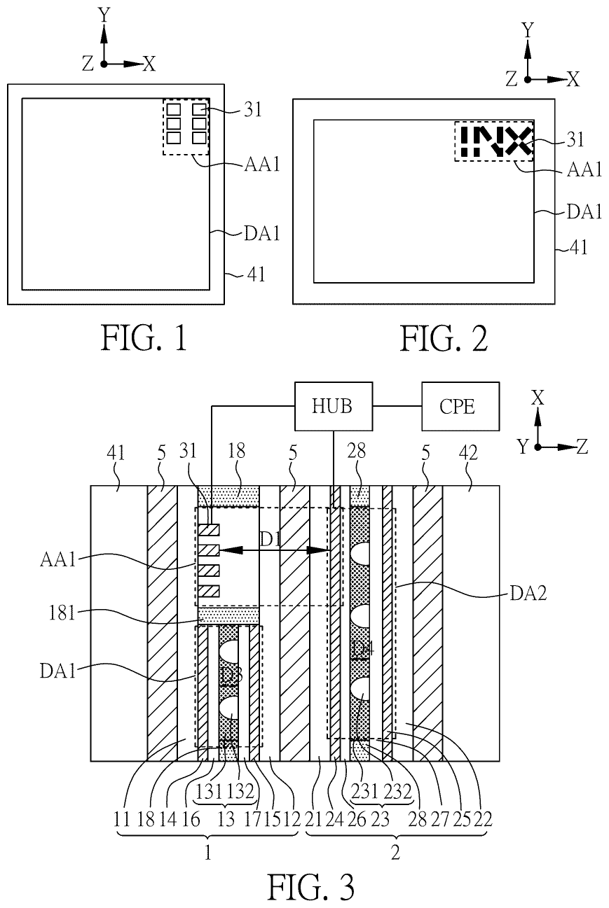

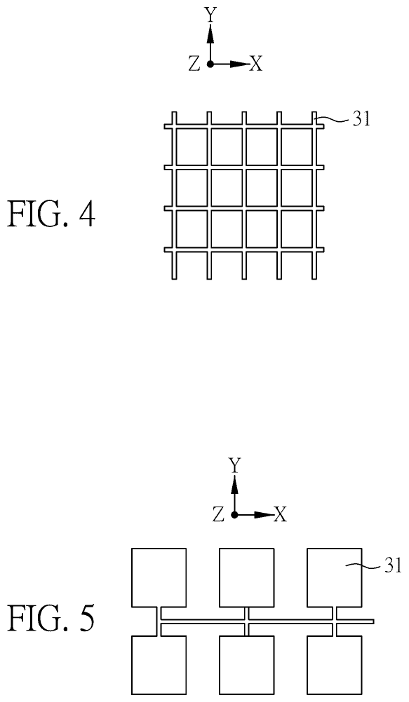

FIG. 1 is a schematic view showing positions of a first dimming area and a first antenna area of an electronic device according to one embodiment of the present disclosure. FIG. 2 is a schematic view showing positions of a first dimming area and a first antenna area of an electronic device according to another embodiment of the present disclosure. FIG. 3 is a cross-sectional schematic view of an electronic device according to one embodiment of the present disclosure. The positions of the first antenna area AA1 and the first antenna electrode 31 in FIG. 1 are only examples, and their sizes and positions in the first dimming area DA1 can be adjusted according to actual needs or designs. For example, the first antenna electrode 31 can be designed to be arranged into a specific LOGO or pattern, as shown in FIG. 2; and for the sake of clarity, some components in FIG. 3 are not shown in FIG. 1.

In one embodiment of the present disclosure, as shown in FIG. 1 and FIG. 3, the electronic device has a first dimming area DA1 and a first antenna area AA1, and comprises a first panel 1 and/or a second panel 2, a first surface substrate 41 and a second surface substrate 42. The first surface substrate 41 and the second surface substrate 42 are opposite to each other, and, for example, are two substrates on two sides of the electronic device. The first panel 1 and/or the second panel 2 are disposed between the first surface substrate 41 and the second surface substrate 42, the first panel 1 is disposed adjacent to the first surface substrate 41, and the second panel 2 is disposed adjacent to the second surface substrate 42. Herein, the first surface substrate 41 is the side close to the outside, and the second surface substrate 42 is the side close to the indoor. The first panel 1 comprises a first substrate 11, a second substrate 12, a first light modulation layer 13 and a first antenna electrode 31. The second substrate 12 is opposite to the first substrate 11. The first light modulation layer 13 is disposed between the first substrate 11 and the second substrate 12 and located in the first dimming area DA1. The first antenna electrode 31 is disposed on a side of the first substrate 11 adjacent to the first light modulation layer 13 and located in the first antenna area AA1. Herein, the first light modulation layer 13 comprises a first liquid crystal material 131 and a first liquid crystal spacer 132. Herein, the first dimming area DA1 and the first antenna area AA1 are not overlapped. More specifically, a part of the first panel 1 is used as an antenna area, and thus the antenna function can be integrated into the electronic device to receive external signals, thereby reducing the thickness of the electronic device or reducing the cost. In addition, the electronic device further comprises a spacer 181 disposed between the first dimming area DA1 and the first antenna area AA1.

In addition, as shown in FIG. 3, the first panel 1 may further comprise a first electrode layer 14 and a second electrode layer 15, the first electrode layer 14 may be disposed between the first substrate 11 and the first light modulation layer 13, and the second electrode layer 15 may be disposed between the first light modulation layer 13 and the second substrate 12. Herein, the electric field generated by the voltage applied between the first electrode layer 14 and the second electrode layer 15 can drive the arrangement of the first liquid crystal material 131 in the first light modulation layer 13, and the state of the first liquid crystal material 131 (the rotation angle of the first liquid crystal material 131) is changed, thereby achieving a dimming effect. In addition, the first liquid crystal material 131 of the first light modulation layer 13 may comprise guest host type liquid crystals (GHLCs), or a liquid crystal material with switchable haze and transmittance such as polymer-dispersed liquid crystals (PDLCs), polymer network liquid crystals (PNLCs), cholesteric liquid crystals or other suitable liquid crystals, but the present disclosure is not limited thereto.

As shown in FIG. 3, the first panel 1 may further comprise a first alignment layer 16 and a second alignment layer 17, the first alignment layer 16 may be disposed between the first electrode layer 14 and the first light modulation layer 13, and the second alignment layer 17 may be disposed between the first light modulation layer 13 and the second electrode layer 15. The first alignment layer 16 has a first rubbing direction (not shown in the figure) and the second alignment layer 17 has a second rubbing direction (not shown in the figure). The first rubbing direction and the second rubbing direction respectively refer to the directions of mechanical rubbing on the first alignment layer 16 and the second alignment layer 17 to achieve the effect of liquid crystal alignment, but the present disclosure is not limited thereto. The first alignment layer 16 and the second alignment layer 17 may also be a photo-alignment film respectively.

As shown in FIG. 3, the first panel 1 may further comprise a first sealant 18 disposed between the first substrate 11 and the second substrate 12. For example, a part of the first sealant 18 may be disposed between the first alignment layer 16 and the second alignment layer 17 and surround the first light modulation layer 13, so the first liquid crystal material 131 in the first light modulation layer 13 is disposed in the space formed by the first alignment layer 16, the second alignment layer 17 and the first sealant 18, but the present disclosure is not limited thereto.

As shown in FIG. 3, the second panel 2 may comprise a second dimming area DA2 and may comprise a third substrate 21, a fourth substrate 22, a second light modulation layer 23, a third electrode layer 24, a fourth electrode layer 25, a third alignment layer 26, a fourth alignment layer 27 and/or a second sealant 28. The fourth substrate 22 may be opposite to the third substrate 21. The second light modulation layer 23 may be disposed between the third substrate 21 and the fourth substrate 22 and may be located in the second dimming area DA2. The second light modulation layer 23 and the first antenna area AA1 may be overlapped. The second light modulation layer 23 may be disposed on a side of the second substrate 12 away from the first light modulation layer 13. The second light modulation layer 23 may comprise a second liquid crystal material 231 and a second liquid crystal spacer 232. The third electrode layer 24 may be disposed between the third substrate 21 and the second light modulation layer 23, and the fourth electrode layer 25 may be disposed between the second light modulation layer 23 and the fourth substrate 22. The third alignment layer 26 may be disposed between the third electrode layer 24 and the second light modulation layer 23, and the fourth alignment layer 27 may be disposed between the second light modulation layer 23 and the fourth electrode layer 25. The second sealant 28 may be disposed between the third substrate 21 and the fourth substrate 22, and for example, the second sealant 28 may be disposed between the third alignment layer 26 and the fourth alignment layer 27 and may surround the second light modulation layer 23. Herein, the first dimming area DA and the second dimming area DA2 are overlapped, and the second dimming area DA2 and the first antenna area AA1 are overlapped, but the present disclosure is not limited thereto. The second panel 2 may have, for example, a full dimming area, thereby reducing the optical difference between the first dimming area DA1 and the first antenna area AA1 of the first panel 1, but the present disclosure is not limited thereto. In addition, the effects of the components in the second panel 2 are similar to those in the first panel 1, and are not described in detail.

In the present disclosure, as shown in FIG. 3, the first antenna area AA1 of the electronic device may be formed by the first antenna electrode 31 (as the first antenna layer of the first antenna area AA1) and a part of the third electrode layer 24 (as the second antenna layer of the first antenna area AA1, and as a ground electrode) (that is, the first antenna layer is disposed in the first panel 1, and the second antenna layer is shared with the third electrode layer 24 and disposed in the second panel 2), and the first antenna electrode 31 and the third electrode layer 24 can be connected to the customer premises equipment CPE via the hub HUB respectively. Thus, the electrode of the first antenna area AA1 can be used to receive signals (for example, 5G or signals with other frequencies), the hub HUB controls and determines whether the signal is transmitted to the customer premises equipment CPE. After receiving the signal, the customer premises equipment CPE can convert it into a wireless signal (such as a WiFi signal or other suitable signal). Herein, the hub HUB is connected to one customer premises equipment CPE, but the present disclosure is not limited thereto, and the hub HUB may also be connected to plural customer premises equipments CPE located in different rooms or spaces. In addition, in the present disclosure, the hub HUB and the customer premises equipment CPE are, for example, two separate devices connected to each other, but the present disclosure is not limited thereto, and the hub HUB can also be integrated into customer premises equipment CPE.

In the present disclosure, as shown in FIG. 3, a distance D1 between the first antenna electrode 31 and the third electrode layer 24 (that is, the distance between the first antenna layer and the second antenna layer of the first antenna area AA1) may be greater than or equal to the thickness D3 of the first liquid crystal material 131 of the first panel 1 and/or the thickness D4 of the second liquid crystal material 231 of the second panel 2. Herein, the distance D1 may be greater than the thickness D3 of the first liquid crystal material 131 of the first panel 1 and/or the thickness D4 of the second liquid crystal material 231 of the second panel 2. In the present embodiment and other embodiments of the present disclosure, the distance D1 is the average distance in the Z direction (for example, the average distance of three locations); and the thicknesses of the first liquid crystal material 131 and the second liquid crystal material 231 are respectively the average thicknesses in the Z direction (for example, the average thickness at three locations).

In the present disclosure, as shown in FIG. 3, the first substrate 11, the second substrate 12, the third substrate 21, the fourth substrate 22, the first surface substrate 41 and/or the second surface substrate 42 may respectively comprise a rigid substrate, a flexible substrate or a bendable substrate. The material of the first substrate 11, the second substrate 12, the third substrate 21, the fourth substrate 22, the first surface substrate 41 and/or the second surface substrate 42 may be the same or different. The materials of the first substrate 11, the second substrate 12, the third substrate 21, the fourth substrate 22, the first surface substrate 41 and/or the second surface substrate 42 may respectively comprise glass, quartz, sapphire, ceramics, plastics, polycarbonate (PC), polyimide (PI), polypropylene (PP), polyethylene terephthalate (PET), polymethylmethacrylate (PMMA), other suitable materials or a combination thereof, but the present disclosure is not limited thereto. When the first substrate 11, the second substrate 12, the third substrate 21, the fourth substrate 22, the first surface substrate 41 and the second surface substrate 42 are flexible substrates, the electronic device of the present disclosure may be a flexible electronic device. The hardness or thickness of the first surface substrate 41 and/or the second surface substrate 42 may be, for example, greater than the hardness or thickness of the first substrate 11, the second substrate 12, the third substrate 21 and/or the fourth substrate 22.

In the present disclosure, even not shown in the figure, active components such as transistors, conductive lines (not shown in the figure), insulating layers (not shown in the figure) or a combination thereof may be disposed on the first substrate 11, the second substrate 12, the third substrate 21, and/or the fourth substrate 22, but the present disclosure is not limited thereto.

In the present disclosure, as shown in FIG. 3, the materials of the first electrode layer 14, the second electrode layer 15, the third electrode layer 24, the fourth electrode layer 25 and/or the first antenna electrode 31 may be the same or different. The materials of the first electrode layer 14, the second electrode layer 15, the third electrode layer 24, the fourth electrode layer 25 and/or the first antenna electrode 31 may respectively comprise a transparent conductive material (for example, indium zinc oxide (IZO), indium tin oxide (ITO), indium tin zinc oxide (ITZO), indium gallium zinc oxide (IGZO) or aluminum zinc oxide (AZO)), a non-transparent conductive material (for example, gold, silver or copper) or a combination thereof, but the present disclosure is not limited thereto. Herein, the first electrode layer 14, the second electrode layer 15, the third electrode layer 24 and the fourth electrode layer 25 respectively have a full-surface design or a patterned design (not shown in the figure) and comprise a transparent conductive material, and the first antenna electrode 31 has a patterned design and comprises a transparent conductive material, but the present disclosure is not limited thereto.

In the present disclosure, as shown in FIG. 3, the electronic device may further comprise an adhesive layer 5 disposed between the first light modulation layer 13 and the second light modulation layer 23. More specifically, an adhesive layer 5 may be selectively disposed between adjacent two of the first panel 1, the second panel 2, the first surface substrate 41 and the second surface substrate 42 to adhere the first panel 1, the second panel 2, the first surface substrate 41 and the second surface substrate 42 respectively. The adhesive layer 5 may have, for example, a full-surface design or a patterned design (not shown in the figure) and the material thereof may be a transparent conductive material.

In the present disclosure, as shown in FIG. 3, the material of each adhesive layer 5 may respectively comprise, for example, polyvinyl butyral (PVB), ethylene vinyl acetate (EVA), optical clear adhesive (OCA), optical clear resin (OCR), other suitable material or a combination thereof, but the present disclosure is not limited thereto.

FIG. 4 is a schematic view of a first antenna electrode being a mesh in an electronic device according to another embodiment of the present disclosure. FIG. 5 is a schematic view of a first antenna electrode being a patch in an electronic device according to further another embodiment of the present disclosure. As shown in FIG. 1, FIG. 4 and FIG. 5, in the present disclosure, the first antenna electrode 31 of the electronic device may have a metal mesh form or a patch form, but the present disclosure is not limited thereto. The first antenna electrode 31 may be a metal mesh with small pores or a patch with small pores. The metal mesh is not limited to the form shown in FIG. 4, and the metal mesh may have mesh pores of other shapes or mesh pores of different sizes. The patch is not limited to the form shown in FIG. 5, and different patterns can be designed according to the needs. Since the small pores (not shown in the figure) are dispersed in various areas of the first antenna electrode 31, the light transmittance of the first antenna area AA1 of the electronic device can be further improved, and the optical difference between the first antenna area AA1 and the first dimming area DA1 can be reduced.

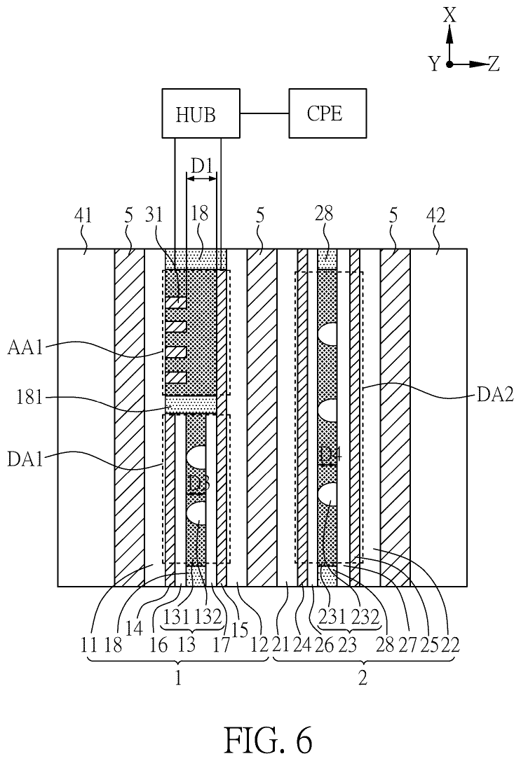

FIG. 6 is a cross-sectional schematic view of an electronic device according to further another embodiment of the present disclosure. Since some features of the embodiment of FIG. 6 are applicable to the description of the embodiment of FIG. 1 and FIG. 3, they are not described in detail, and the following mainly describes the differences. Compared to the embodiment shown in FIG. 1 and FIG. 3, in the embodiment shown in FIG. 6, the first light modulation layer 13 of the electronic device may further be located in the first antenna area AA1, the second electrode layer 15 may be disposed in the first antenna area AA1, and the first antenna area AA1 of the electronic device may be formed by the first antenna electrode 31 (as the first antenna layer of the first antenna area AA1) and a part of the second electrode layer 15 (as the second antenna layer of the first antenna area AA1, and as a ground electrode) (that is, the first antenna layer and the second antenna layer are disposed in the first panel 1).

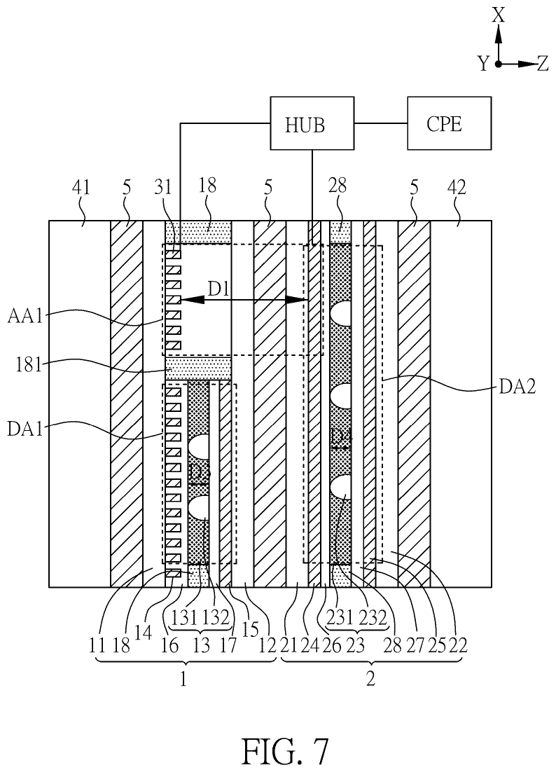

FIG. 7 is a cross-sectional schematic view of an electronic device according to further another embodiment of the present disclosure. Since some features of the embodiment of FIG. 7 are applicable to the description of the embodiment of FIG. 1 and FIG. 3, they are not described in detail, and the following mainly describes the differences. Compared to the embodiment shown in FIG. 1 and FIG. 3, in the embodiment shown in FIG. 7, the first antenna area AA1 of the electronic device may be formed by the first antenna electrode 31 (as the first antenna layer of the first antenna area AA1) and a part of the third electrode layer 24 (as the second antenna layer of the first antenna area AA1, and as a ground electrode) (that is, the first antenna layer is disposed in the first panel 1, and the second antenna layer is disposed in the second panel 2), the first antenna electrode 31 and the first electrode layer 14 may be meshes with small pores or patterned electrodes, and the materials thereof may be a non-transparent conductive material (for example, a metal). In addition, a spacer 181 may be disposed between the first dimming area DA1 and the first antenna area AA1. The meshes or patterns of the first antenna electrode 31 and the first electrode layer 14 may be the same or different.

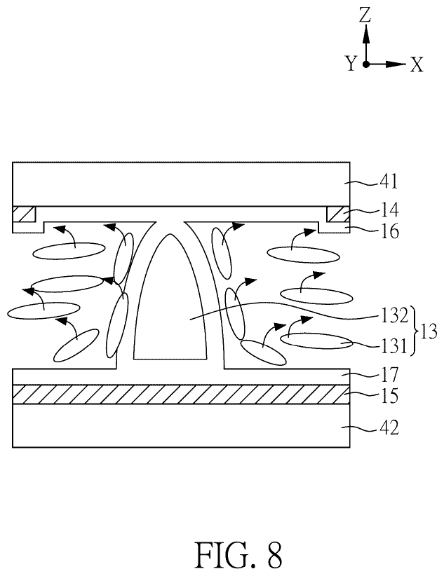

FIG. 8 is a partial cross-sectional schematic view of the electronic device of FIG. 7. As shown in FIG. 7 and FIG. 8, in the case that the first electrode layer 14 and/or the second electrode layer 15 in the first dimming area DA1 of the electronic device is the aforesaid metal mesh or a patch and the material thereof is a non-transparent conductive material, and an electric field is applied to the first electrode layer 14 and the second electrode layer 15, a transverse filed is generated. When the transverse filed is weak or the distance between the first electrode layer 14 and the second electrode layer 15 is too large, the response time of the liquid crystals can be accelerated by setting the first liquid crystal spacer 132 to pre-tilt the first liquid crystal material 131 at an angle, but the present disclosure is not limited thereto.

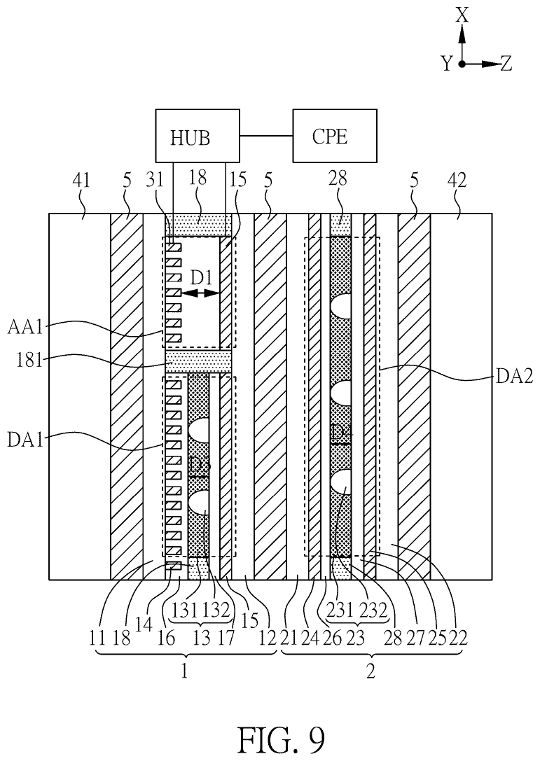

FIG. 9 is a cross-sectional schematic view of an electronic device according to further another embodiment of the present disclosure. Since some features of the embodiment of FIG. 9 are applicable to the description of the embodiment of FIG. 7, they are not described in detail, and the following mainly describes the differences. Compared to FIG. 7, in the embodiment of FIG. 9, the first antenna area AA1 of the electronic device may be formed by the first antenna electrode 31 (as the first antenna layer of the first antenna area AA1) and a part of the second electrode layer 15 (as the second antenna layer of the first antenna area AA1, and as a ground electrode) (that is, both the first antenna layer and the second antenna layer are disposed in the first panel 1). In addition, the first antenna electrode 31 and the first electrode layer 14 are patches with small pores and the materials thereof are non-transparent materials, but the present disclosure is not limited thereto. In other embodiments, similar to the embodiment of FIG. 9, the main difference is that the first electrode layer of the electronic device may have a full-surface design and the material thereof may be a transparent conductive material, and the first antenna electrode may have a patch form. In other embodiments, similar to the embodiment of FIG. 9, the main difference is that the second electrode layer of the electronic device may be a patch with small pores and the material thereof may be a transparent or non-transparent conductive material, but the present disclosure is not limited thereto.

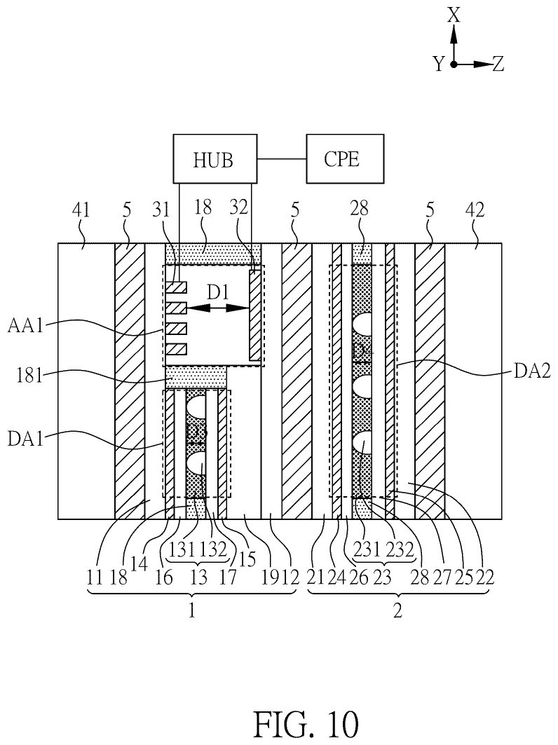

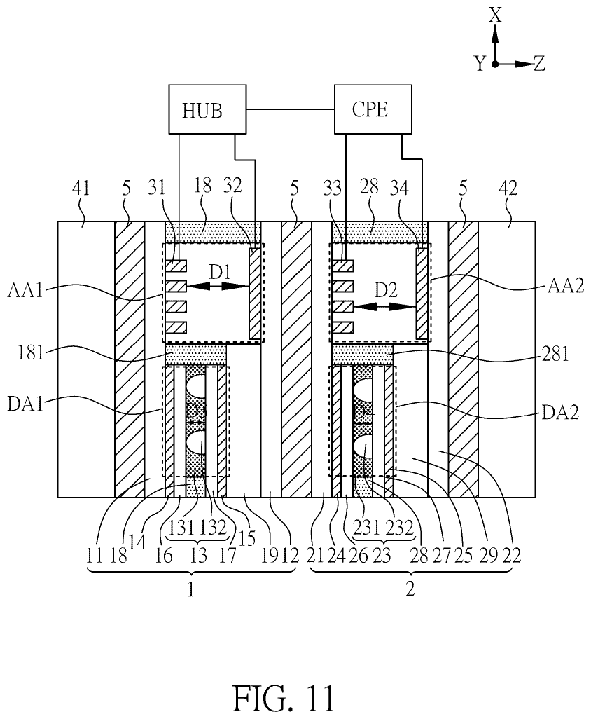

FIG. 10 is a cross-sectional schematic view of an electronic device according to further another embodiment of the present disclosure. Since some features of the embodiment of FIG. 10 are applicable to the description of the embodiment of FIG. 1 and FIG. 3, they are not described in detail, and the following mainly describes the differences. Compared to the embodiments of FIG. 1 and FIG. 3, in the embodiment of FIG. 10, the electronic device may further comprise a first insulating layer 19 and a second antenna electrode 32. The first insulating layer 19 may be disposed between the second electrode layer 15 and the second substrate 12 to adjust the distance D1 by the thickness of the first insulating layer 19, thereby adjusting the frequency of the signal received by the first antenna area AA1. The second antenna electrode 32 may be disposed on a side of the second substrate 12 adjacent to the first light modulation layer 13, and the second antenna electrode 32 may have a full-surface design and the material thereof may be a transparent conductive material. However, the present disclosure is not limited thereto, and the second antenna electrode 32 may have a patterned design, such as a mesh form or a patch form. In addition, the material of the second antenna electrode 32 may be the same as or different from the materials of the first electrode layer 14, the second electrode layer 15, the third electrode layer 24, the fourth electrode layer 25 and/or the first antenna electrode 31 of the above FIG. 3. Furthermore, the first antenna area AA1 may be formed by the first antenna electrode 31 (as the first antenna layer of the first antenna area AA1) and the second antenna electrode 32 (as the second antenna layer of the first antenna area AA1, and as a ground electrode), that is, both the first antenna layer and the second antenna layer are disposed in the first panel 1, but the present disclosure is not limited thereto.

FIG. 11 is a cross-sectional schematic view of an electronic device according to further another embodiment of the present disclosure. Since some features of the embodiment of FIG. 11 are applicable to the description of the embodiment of FIG. 10, they are not described in detail, and the following mainly describes the differences. Compared to the embodiments of FIG. 10, in the embodiment of FIG. 11, the electronic device may further comprise a second insulating layer 29 which may be disposed on a side of the second light modulation layer 23 away from the second substrate 12 (or the third substrate 21). Or, the second insulating layer 29 may be disposed on a side of the second light modulation layer 23 adjacent to the fourth substrate 22. In addition, the electronic device may further comprise a second antenna area AA2, which may be formed by a third antenna electrode 33 (as the third antenna layer of the second antenna area AA2) and a fourth antenna electrode 34 (as the fourth antenna layer of the second antenna area AA2, and as a ground electrode), that is, both the third antenna layer and the fourth antenna layer are disposed in the second panel 2. A spacer 181 may be disposed between the first dimming area DA1 and the first antenna area AA1, and a spacer 281 may be disposed between the second dimming area DA2 and the second antenna area AA2. A distance D1 is between the first antenna electrode 31 and the second antenna electrode 32, a distance D2 is between the third antenna electrode 33 and the fourth antenna electrode 34, and the distance D1 and/or the distance D2 may be greater than or equal to the thickness D3 of the first liquid crystal material 131 of the first panel 1 and/or the thickness D4 of the second liquid crystal material 231 of the second panel 2. In the present embodiment and other embodiments of the present disclosure, the distance D1 is the average distance between the first antenna electrode 31 and the second antenna electrode 32 in the Z direction (the average distance of three positions), the distance D2 is an average distance between the third antenna electrode 33 and the fourth antenna electrode 34 in the Z direction (the average distance of three positions), and the thicknesses of the first liquid crystal material 131 and the second liquid crystal material 231 are average thicknesses in the Z direction (the average thickness of three positions).

Herein, the first antenna area AA1 and the second antenna area AA2 may be overlapped. The first antenna area AA1 and the second antenna area AA2 may be completely overlapped, or the first antenna area AA1 and the second antenna area AA2 may be at least partially overlapped. In a top view or from the Z direction, the size or shape of the first antenna area AA1 may be the same as or different from that of the second antenna area AA2. The rest portion of the second antenna area AA2 may be similar to the first antenna area AA1, and the material of the third antenna electrode 33 and/or the fourth antenna electrode 34 is similar to the materials of the first electrode layer 14, the second electrode layer 15, the third electrode layer 24, the fourth electrode layer 25 and/or the first antenna electrode 31 described in FIG. 3, and are not described in detail.

In addition, in the present embodiment and other embodiments of the present disclosure, the first antenna electrode 31 and the second antenna electrode 32 may be connected to the hub HUB respectively, and the third antenna electrode 33 and the fourth antenna electrode 34 may be connected to the customer premises equipment CPE respectively, but the present disclosure is not limited thereto. The first antenna electrode 31, the second antenna electrode 32, the third antenna electrode 33 and the fourth antenna electrode 34 may be connected to the customer premises equipment CPE through the hub HUB respectively. Thus, the electrodes of the first antenna area AA1 and the electrodes of the second antenna area AA2 may be used to receive signals (for example, 5G or signals with other frequencies), and the hub HUB controls and determines whether the signal is transmitted to the customer premises equipment CPE. After receiving the signal, the customer premises equipment CPE can convert it into a wireless signal (such as a WiFi signal or other suitable signal). Herein, the hub HUB is connected to one customer premises equipment CPE, but the present disclosure is not limited thereto, and the hub HUB may also be connected to plural customer premises equipments CPE located in different rooms or spaces. In addition, in the present disclosure, the hub HUB and the customer premises equipment CPE are, for example, two separate devices connected to each other, but the present disclosure is not limited thereto, and the hub HUB can also be integrated into customer premises equipment CPE.

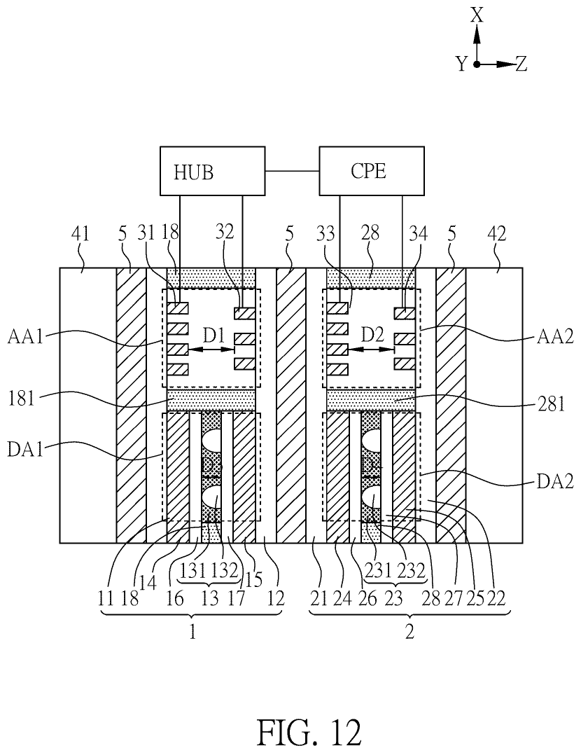

FIG. 12 is a cross-sectional schematic view of an electronic device according to further another embodiment of the present disclosure. Since some features of the embodiment of FIG. 12 are applicable to the description of the embodiment of FIG. 1 and FIG. 3, they are not described in detail, and the following mainly describes the differences. Compared to the embodiments of FIG. 1 and FIG. 3, in the embodiment of FIG. 12, the electronic device may further comprise a second antenna electrode 32, a third antenna electrode 33 and a fourth antenna electrode 34, the second antenna electrode 32 may be disposed between the second substrate 12 and the first light modulation layer 13, a distance D1 between the first antenna electrode 31 and the second antenna electrode 32 may be greater than or equal to the thickness D3 of the first light modulation layer 13 in the first dimming area DA1, and the distance D2 between the third antenna electrode 33 and the fourth antenna electrode 34 may be greater than or equal to the thickness D4 of the second light modulation layer 23 in the second dimming area DA2. The first antenna area AA1 may be formed by the first antenna electrode 31 (as the first antenna layer of the first antenna area AA1) and the second antenna electrode 32 (as the second antenna layer of the first antenna area AA1, and as a ground electrode), that is, both the first antenna layer and the second antenna layer are disposed in the first panel 1. The second antenna area AA2 may be formed by the third antenna electrode 33 (as the third antenna layer of the second antenna area AA2) and the fourth antenna electrode 34 (as the fourth antenna layer of the second antenna area AA2, and as a ground electrode), that is, both the third antenna layer and the fourth antenna layer are disposed in the second panel 2. In addition, the first antenna electrode 31, the second antenna electrode 32, the third antenna electrode 33 and the fourth antenna electrode 34 may be patterned and the materials thereof may be a transparent conductive material, but the present disclosure is not limited thereto. In addition, a spacer 181 may be disposed between the first dimming area DA1 and the first antenna area AA1, and a spacer 281 may be disposed between the second dimming area DA2 and the second antenna area AA2, but the present disclosure is not limited thereto. Herein, the first antenna area AA1 and the second antenna area AA2 may be overlapped. The first antenna area AA1 and the second antenna area AA2 may be completely overlapped, or the first antenna area AA1 and the second antenna area AA2 may be at least partially overlapped. In a top view or from a Z direction, the size or shape of the first antenna area AA1 may be the same or different from that of the second antenna area AA2.

In addition, in the present embodiment and other embodiments of the present disclosure, the first antenna electrode 31 and the second antenna electrode 32 may be connected to a hub HUB respectively, and the third antenna electrode 33 and the fourth antenna electrode 34 may be connected to a customer premises equipment CPE respectively, but the present disclosure is not limited thereto. The first antenna electrode 31, the second antenna electrode 32, the third antenna electrode 33 and the fourth antenna electrode 34 may be connected to the customer premises equipment CPE through the hub HUB respectively. Thus, the electrodes of the first antenna area AA1 and the electrodes of the second antenna area AA2 may be used to receive signals (for example, 5G or signals with other frequencies), and the hub HUB controls and determines whether the signal is transmitted to the customer premises equipment CPE. After receiving the signal, the customer premises equipment CPE can convert it into a wireless signal (such as a WiFi signal or other suitable signal). Herein, the hub HUB is connected to one customer premises equipment CPE, but the present disclosure is not limited thereto, and the hub HUB may also be connected to plural customer premises equipments CPE located in different rooms or spaces. In the present disclosure, the hub HUB and the customer premises equipment CPE are, for example, two separate devices connected to each other, but the present disclosure is not limited thereto, and the hub HUB can also be integrated into customer premises equipment CPE.

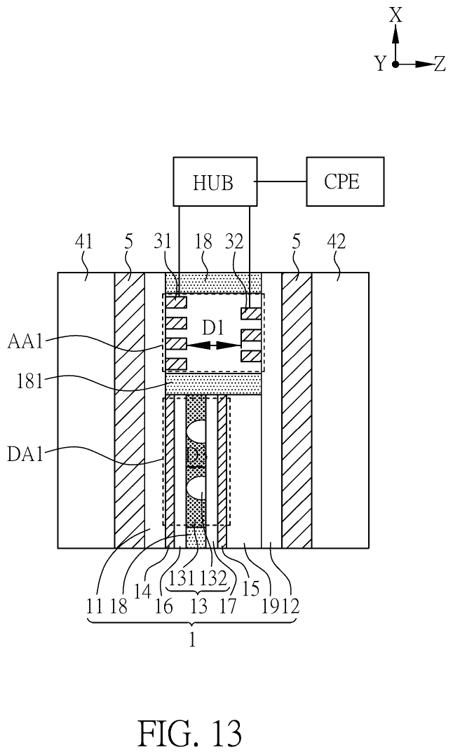

FIG. 13 is a cross-sectional schematic view of an electronic device according to further another embodiment of the present disclosure. Since some features of the embodiment of FIG. 13 are applicable to the description of the embodiment of FIG. 12, they are not described in detail, and the following mainly describes the differences. Compared to the embodiments of FIG. 12, in the embodiment of FIG. 13, the electronic device, for example, only comprises a first panel 1, and the first panel 1 may further comprises a first insulating layer 19 which may be disposed between the first light modulation layer 13 and the second substrate 12. A spacer 181 is disposed between the first dimming area DA1 and the first antenna area AA1. In addition, the electronic device is not disposed with the second panel 2 of the embodiment shown in FIG. 13.

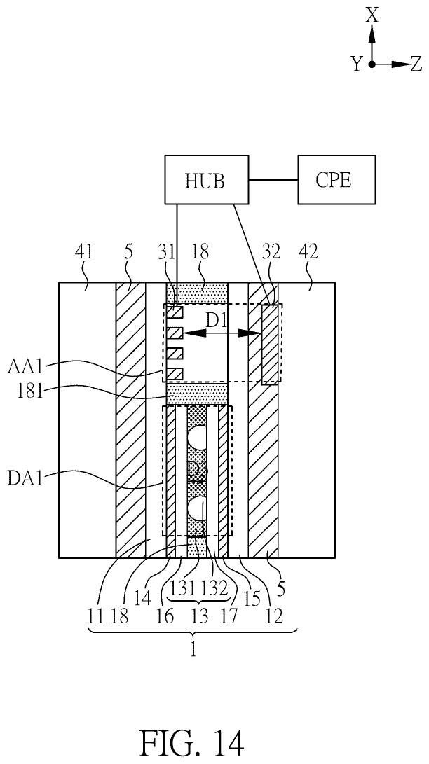

FIG. 14 is a cross-sectional schematic view of an electronic device according to further another embodiment of the present disclosure. Since some features of the embodiment of FIG. 14 are applicable to the description of the embodiment of FIG. 13, they are not described in detail, and the following mainly describes the differences. Compared to the embodiments of FIG. 13, in the embodiment of FIG. 14, the first antenna area AA1 of the electronic device may be formed by the first antenna electrode 31 (as the first antenna layer of the first antenna area AA1) and the second antenna electrode 32 (as the second antenna layer of the first antenna area AA1, and as a ground electrode); that is, the first antenna layer is disposed in the first panel 1, the second antenna layer is disposed, for example, outside the first panel 1, and the second antenna electrode 32 may be disposed on a side of the second substrate 12 away from the first light modulation layer 13. Herein, a distance D1 between the first antenna electrode 31 and the second antenna electrode 32 may be greater than the thickness D3 of the first light modulation layer 13 in the first dimming area DA1. More specifically, the second antenna electrode 32 may be disposed between the second surface substrate 42 and the second substrate 12, the adhesive layer 5 may be disposed between the second surface substrate 42 and the second substrate 12, the adhesive layer 5 may cover the second antenna electrode 32, and the second antenna electrode 32 and the second substrate 12 may be separated by an adhesive layer 5, but the present disclosure is not limited thereto. In other embodiments (not shown in the figure), the second antenna electrode 32 and the second surface substrate 42 may be separated by an adhesive layer 5, but the present disclosure is not limited thereto. The material of the second antenna electrode 32 may be a transparent or non-transparent conductive material (such as gold, silver or copper). In addition, in the embodiment of FIG. 14, the electronic device is not disposed with the first insulating layer 19 in the embodiment shown in FIG. 13.

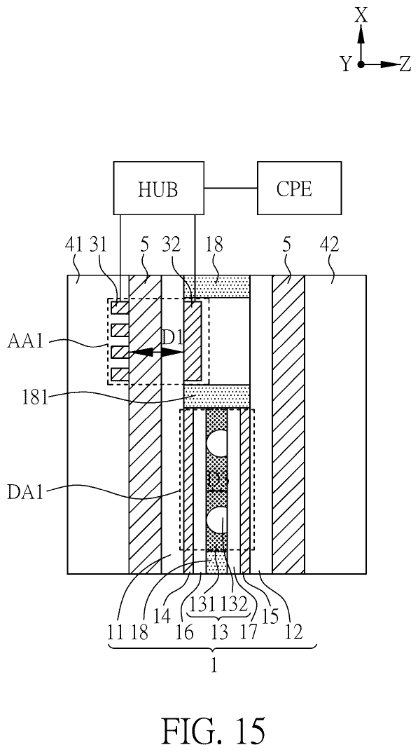

FIG. 15 is a cross-sectional schematic view of an electronic device according to further another embodiment of the present disclosure. Since some features of the embodiment of FIG. 15 are applicable to the description of the embodiment of FIG. 14, they are not described in detail, and the following mainly describes the differences. Compared to the embodiments of FIG. 14, in the embodiment of FIG. 15, the first antenna area AA1 of the electronic device may be formed by the first antenna electrode 31 (as the first antenna layer of the first antenna area AA1) and the second antenna electrode 32 (as the second antenna layer of the first antenna area AA1, and as a ground electrode). That is, the first antenna layer is disposed outside the first panel 1 and adjacent to the first surface substrate 41, and the second antenna layer is disposed in the first panel 1, wherein the first antenna electrode 31 may be disposed between the first surface substrate 41 and the first substrate 11, the adhesive layer 5 may be disposed between the first surface substrate 41 and the first substrate 11, and the first antenna electrode 31 and the first substrate 11 are separated by an adhesive layer 5. The second antenna electrode 32 may be disposed between the first substrate 11 and the second substrate 12. Herein, the first antenna electrode 31 may be patterned and the material thereof may be a transparent or non-transparent material, but the present disclosure is not limited thereto. The first antenna electrode 31 may have a full-surface design, the second antenna electrode 32 may have a full-surface design, and the material thereof may be a transparent conductive material, but the present disclosure is not limited thereto.

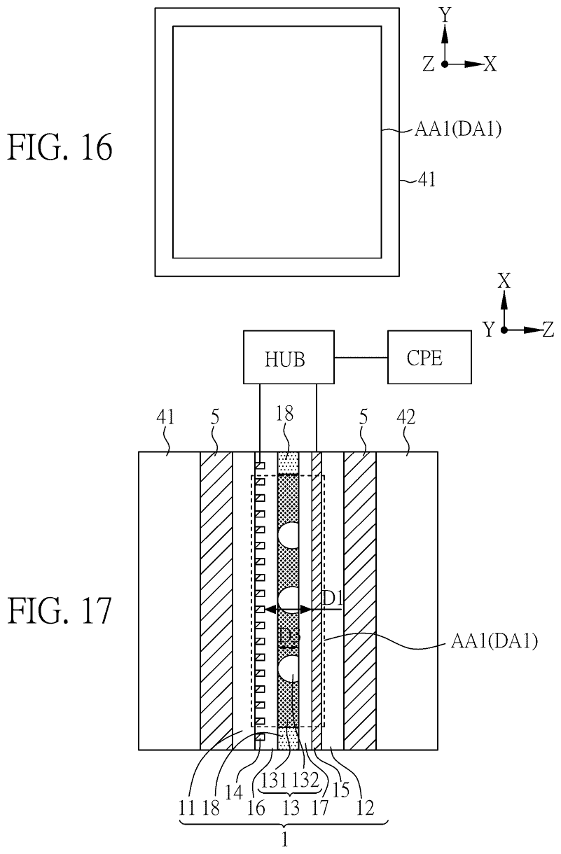

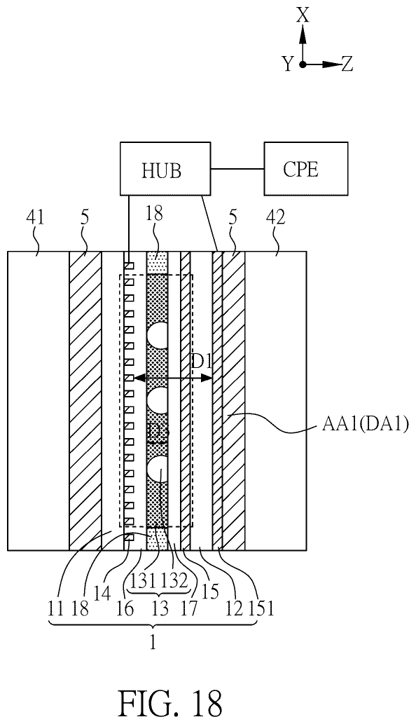

FIG. 16 is a schematic view showing positions of a dimming area and an antenna area of an electronic device according to another embodiment of the present disclosure. FIG. 17 is a cross-sectional schematic view of an electronic device according to further another embodiment of the present disclosure. In FIG. 16, the first antenna area AA1 and the first dimming area DA1 may be approximately overlapped. From the Z direction, the size or shape of the first antenna area AA1 may be approximately the same as that of the first dimming area DA1. For clarity, some components in FIG. 17 are not shown in FIG. 16.

In one embodiment of the present disclosure, as shown in FIG. 16 and FIG. 17, the first dimming area DA1 and the first antenna area AA1 of the electronic device may be overlapped. More specifically, the first antenna area AA1 may be formed by the first electrode layer 14 (as the first antenna layer of the first antenna area AA1) and the second electrode layer 15 (as the second antenna layer of the first antenna area AA1, and as a ground electrode). Herein, the first electrode layer 14 and the second electrode layer 15 may have, for example, a full-surface design, a mesh form or a patch form, and the materials thereof may respectively comprise a transparent conductive material, a non-transparent conductive material or a combination thereof.

FIG. 18 is a cross-sectional schematic view of an electronic device according to further another embodiment of the present disclosure. Since some features of the embodiment of FIG. 18 are applicable to the description of the embodiment of FIG. 17, they are not described in detail, and the following mainly describes the differences. Compared to the embodiments of FIG. 17, in the embodiment of FIG. 18, the electronic device may further comprise a fifth electrode layer 151 disposed on a side of the second substrate 12 away from the first light modulation layer 13. The fifth electrode layer 151 may be disposed between the second substrate 12 and the second surface substrate 42, the adhesive layer 5 may be disposed between the second surface substrate 42 and the second substrate 12, and the fifth electrode layer 151 and the second surface substrate 42 may be separated by an adhesive layer 5, but the present disclosure is not limited thereto. In other embodiments (not shown in the figure), the fifth electrode layer 151 and the second substrate 12 may be separated by an adhesive layer 5, but the present disclosure is not limited thereto. In addition, the first antenna area AA1 of the electronic device may be formed by the first electrode layer 14 (as the first antenna layer of the first antenna area AA1) and the fifth electrode layer 151 (as the second antenna layer of the first antenna area AA1, and as a ground electrode). Herein, the first electrode layer 14 is similar to the first electrode layer 14 shown in FIG. 17, the second electrode layer 15 is similar to the second electrode layer 15 shown in FIG. 17, and the fifth electrode layer 151 has a full-surface design. In the present disclosure, for example, the electric field generated by the voltage applied between the first electrode layer 14 and the second electrode layer 15 can drive the arrangement of the first liquid crystal material 131 in the first light modulation layer 13, and the state of the first liquid crystal material 131 is changed to achieve the effect of light concentration or light dispersion. In other embodiments, the first electrode layer 14, the second electrode layer 15 and the fifth electrode layer 151 may have a full-surface design, a mesh form or a patch form, and the materials thereof may respectively comprise a transparent conductive material, a non-transparent conductive material or a combination thereof.

The above specific embodiments should be construed as merely illustrative and not limiting in any way the remainder of the present disclosure.

Although the present disclosure has been explained in relation to its embodiment, it is to be understood that many other possible modifications and variations can be made without departing from the spirit and scope of the disclosure as hereinafter claimed.

1. An electronic device having a dimming area and an antenna area, and comprising:
a first substrate;
a second substrate opposite to the first substrate;
a first light modulation layer disposed between the first substrate and the second substrate and located in the dimming area; and
a first antenna electrode disposed on a side of the first substrate adjacent to the first light modulation layer and located in the antenna area,
wherein the first light modulation layer comprises a liquid crystal material.

2. The electronic device of claim 1, further comprising another antenna area, wherein the antenna area and the another antenna area are overlapped.

3. The electronic device of claim 1, wherein the dimming area and the antenna area are not overlapped.

4. The electronic device of claim 3, further comprising a spacer disposed between the dimming area and the antenna area.

5. The electronic device of claim 1, wherein the dimming area and the antenna area are overlapped.

6. The electronic device of claim 1, wherein the first light modulation layer is further located in the antenna area.

7. The electronic device of claim 1, further comprising a second antenna electrode disposed on a side of the second substrate away from the first light modulation layer, wherein a distance between the first antenna electrode and the second antenna electrode is greater than a thickness of the first light modulation layer located in the dimming area.

8. The electronic device of claim 1, further comprising a second antenna electrode disposed between the second substrate and the first light modulation layer, wherein a distance between the first antenna electrode and the second antenna electrode is greater than a thickness of the first light modulation layer locating in the dimming area.

9. The electronic device of claim 1, further comprising a first insulating layer disposed between the first light modulation layer and the second substrate.

10. The electronic device of claim 1, further comprising a second light modulation layer disposed on a side of the second substrate away from the first light modulation layer.

11. The electronic device of claim 10, wherein the second light modulation layer and the antenna area are overlapped.

12. The electronic device of claim 10, further comprising an insulating layer disposed on a side of the second light modulation layer away from the second substrate.

13. The electronic device of claim 10, further comprising an adhesive layer disposed between the first light modulation layer and the second light modulation layer.

14. The electronic device of claim 1, wherein the first antenna electrode has a mesh form or a patch form.

15. The electronic device of claim 1, further comprising:
a third substrate;
a fourth substrate opposite to the third substrate;
a second light modulation layer disposed between the third substrate and the fourth substrate; and
an electrode layer disposed between the third substrate and the second light modulation layer,
wherein the antenna area is formed by the first antenna electrode and a part of the electrode layer.

16. The electronic device of claim 15, wherein the first antenna electrode and the electrode layer are connected to a customer premises equipment via a hub.

17. The electronic device of claim 15, wherein a distance between the first antenna electrode and the electrode layer is greater than or equal to a thickness of the first light modulation layer or a thickness of the second light modulation layer.

18. The electronic device of claim 1, further comprising an electrode layer disposed between the first light modulation layer and the second substrate, wherein the antenna area is formed by the first antenna electrode and a part of the electrode layer.

19. The electronic device of claim 1, further comprising:
an electrode layer disposed between the first light modulation layer and the second substrate; and
a second antenna electrode disposed on a side of the second substrate adjacent to the first light modulation layer,
wherein the antenna area is formed by the first antenna electrode and the second antenna electrode.

20. The electronic device of claim 19, further comprising: a first insulating layer disposed between the electrode layer and the second substrate.
